(19) United States
(12) Patent Application Publication
(10) Pub. No.: US 2021/0394276 A1
(43) Pub. Date: Dec. 23, 2021

(54) WORKPIECE PROCESSING ASSEMBLY WITH MULTIPLE WORKING OPERATIONS

(71) Applicant: YU-HONG TECHNOLOGY CO., LTD., KAOHSIUNG CITY (TW)

(72) Inventor: SHENG-FANG TSAI, KAOHSIUNG CITY (TW)

(21) Appl. No.: 16/909,094

(22) Filed: Jun. 23, 2020

(51) Int. Cl. B23B 3/16; B23Q 39/00

(52) U.S. Cl. CPC B23B 3/168; B23Q 2039/008; B23Q 39/00

(57) ABSTRACT

A workpiece processing assembly with multiple working operations includes a working platform, a first positioning device disposed thereon, a second positioning device situated relative to the first positioning device, a first turning device situated beside the first positioning device, a second turning device situated beside the second positioning device, and a controlling device. The turning devices each are equipped with at least two processing tools. A first transverse slide rail disposed on the working platform serves to adjust the distance between the positioning devices, thereby clamping at least one workpiece firmly. Two longitudinal slide rails respectively disposed on the working platform serve to adjust the distance between each turning device and each corresponding positioning device, thereby moving the processing tools to a proper processing position. Thus, the inconvenience caused by replacing the processing tools during the turning process is prevented, and the processing efficiency is greatly increased.

### BACKGROUND OF THIS INVENTION

### 1. Field of this Invention

This invention relates to a processing assembly and relates particularly to a workpiece processing assembly with multiple working operations.

### 2. Description of the Related Art

Since a conventional processing machine can only be equipped with one processing tool, a workpiece should be processed through different processing machines separately in order to complete multiple working operations of the turning process. Alternatively, the processing tool of the processing machine can be changed manually after each working operation is completed in order to complete multiple working operations of the turning process with one processing machine. However, it affects the smoothness of the turning process and complicates the turning process. Further, the precision of the finished workpiece may be poor.

A machine tool 1 is disclosed in a PCT Application Publication No. 2016/063837, as shown in FIG. 1, the machine tool 1 comprises a working platform 11, a first positioning device 12 disposed on the working platform 11, a second positioning device 13 situated relative to the first positioning device 12, a first turning device 14 situated beside the first positioning device 12, a second turning device 15 situated beside the second positioning device 13, and a controlling device 16 electrically connected to the first positioning device 12, the second positioning device 13, the first turning device 14 and the second turning device 15. The working platform 11 defines a three-dimensional baseline including a Y-axis direction, an X-axis direction perpendicular to the Y-axis direction, and a Z-axis direction pointing upward. The first positioning device 12 is fixed on the working platform 11 and adapted to clamp one end of a workpiece 2 to be processed. The second positioning device 13 is movably disposed on a first transverse slide rail 131 and a first longitudinal slide rail 132 for being adapted to slide in the X-axis direction and the Y-axis direction reciprocatingly. The second positioning device 13 is adapted to clamp another end of the workpiece 2. Alternatively, the first positioning device 12 and the second positioning device 13 can adapted to clamp different workpieces 2 to be processed. The first turning device 14 is movably disposed on a second transverse slide rail 141 and a second longitudinal slide rail 142 for being adapted to slide in the X-axis direction and the Y-axis direction reciprocatingly. The first turning device 14 has a first carrier 143 adapted to accommodate at least one processing tool (not shown). The second turning device 15 has a support base 151 fixed on the working platform 11, a second carrier 152 adapted to accommodate at least one processing tool (not shown), and a flat surface 153 formed on the second carrier 152. Referring to FIG. 1, and FIGS. 2A-2B, the controlling device 16 can actuate the second turning device 15 based on a control command to carry out a rotation of the second carrier 152 and situate the flat surface 153 relative to the second positioning device 13. Thus, the second positioning device 13 can slide on the first transverse slide rail 131 in the X-axis direction without being hindered by the second carrier 152. Hence, the second turning device 15 and the second positioning device 13 will not interfere each other during the turning process to thereby complete the turning process.

Although the machine tool 1 can complete multiple working operations of the turning process, the second turning device 15 is unable to process the workpiece 2 when the first positioning device 12 and the second positioning device 13 clamp the same workpiece 2. When the second positioning device 13 slides on the first transverse slide rail 131 toward the first positioning device 12 to adjust the distance between the first positioning device 12 and the second positioning device 13 in order to clamp the workpiece 2 stably, the second carrier 152 must be rotated to allow the flat surface 153 to face the second positioning device 13 to thereby prevent the second positioning device 13 from colliding with the second carrier 152. However, the flat surface 153 is unable to carry any processing tool, and that causes the second turning device 15 is unable to process the workpiece 2. Thus, all processing tools needed for processing the workpiece 2 must be installed on the first carrier 143 of the first turning device 14. If the first carrier 143 is unable to accommodate all processing tools, the processing tools of the first carrier 143 should be replaced manually in order to complete multiple working operations. Further, if the end of the workpiece 2 clamped by the second positioning device 13 should be processed, the workpiece 2 should be removed to situate the end of the workpiece 2 which is formerly clamped by the second positioning device 13 to be clamped by the first positioning device 12 in order that two ends of the workpiece 2 can be processed by the first turning device 14 respectively. Hence, the turning process becomes complicated and time-consuming. The processing efficiency is poor. The processing quality is difficult to be controlled, and that requires to be improved.

### SUMMARY OF THIS INVENTION

The object of this invention is to provide a workpiece processing assembly with multiple working operations capable of simultaneously processing the same workpiece or different workpieces, executing multiple working operations smoothly and speedily, avoiding the inconvenience caused by replacing processing tools, and increasing the processing efficiency effectively.

The workpiece processing assembly with multiple working operations of this invention includes a working platform, a positioning assembly disposed on the working platform and adapted to clamp at least one workpiece to be processed, a first turning device and a second turning device located beside the positioning assembly, and a controlling device electrically connected to the positioning assembly, the first turning device and the second turning device for actuating respective operations of the positioning assembly, the first turning device and the second turning device according to a control command transmitted to the controlling device. The working platform includes a processing portion and an operating portion located relative to the processing portion. The processing portion defines at least a first processing area and at least a second processing area defined relative to the first processing area. The operating portion defines at least a first operating area defined beside the first processing area and at least a second operating area defined beside the second processing area. The working platform has a first transverse slide rail disposed in the second processing area, a second transverse slide rail disposed in the first operating area, a first longitudinal slide rail slidably disposed on the second transverse slide rail, and a second longitudinal slide rail disposed in the second operating area. The working platform defines a three-dimensional baseline including a Y-axis direction, an X-axis direction perpendicular to the Y-axis direction, and a Z-axis direction pointing upward. The positioning assembly has a first positioning device situated in the first processing area and a second positioning device movably disposed on the first transverse slide rail of the second processing area for being adapted to slide in the X-axis direction reciprocatingly. The second positioning device is positioned relative to the first positioning device. The first turning device is movably disposed on the first longitudinal slide rail of the first operating area for being adapted to slide in the Y-axis direction reciprocatingly and to move in the X-axis direction reciprocatingly by sliding the first longitudinal slide rail along the second transverse slide rail. The first turning device is situated beside the first positioning device and has a first carrier adapted to install at least two first processing tools serving to turn the workpiece. The second turning device is movably disposed on the second longitudinal slide rail of the second operating area for being adapted to slide in the Y-axis direction reciprocatingly. The second turning device is situated beside the second positioning device and has a second carrier adapted to install at least two second processing tools serving to turn the workpiece. Thus, the second positioning device can slide on the first transverse slide rail to adjust the distance between the first positioning device and the second positioning device to thereby clamp the workpiece stably. Meanwhile, the first turning device can slide on the first longitudinal slide rail and the second turning device can slide on the second longitudinal slide rail to situate the first processing tool and the second processing tool in a proper processing position. Further, the first carrier and the second carrier is actuated to change the needed first processing tool and the needed second processing tool automatically. Hence, multiple working operations can be executed smoothly and speedily. The inconvenience caused by replacing processing tools during the turning process is prevented, and the processing efficiency is increased effectively.

Preferably, the first positioning device is adapted to clamp one end of the workpiece. The second positioning device is adapted to clamp another end of the workpiece.

Preferably, the first positioning device and the second positioning device are adapted to clamp different workpieces.

Preferably, the first turning device is movably disposed on a first elevating unit for being adapted to slide in the Z-axis direction reciprocatingly.

Preferably, the second turning device is movably disposed on a second elevating unit for being adapted to slide in the Z-axis direction reciprocatingly.

Preferably, the first transverse slide rail extends from the first processing area to the second processing area. The first positioning device and the second positioning device are movably disposed on the first transverse slide rail for being adapted to slide in the X-axis direction reciprocatingly. The first turning device is movably disposed on the first longitudinal slide rail for being adapted to only slide in the Y-axis direction reciprocatingly.

### BRIEF DESCRIPTION OF THE DRAWINGS

FIG. 1 is a schematic view showing a conventional machine tool;

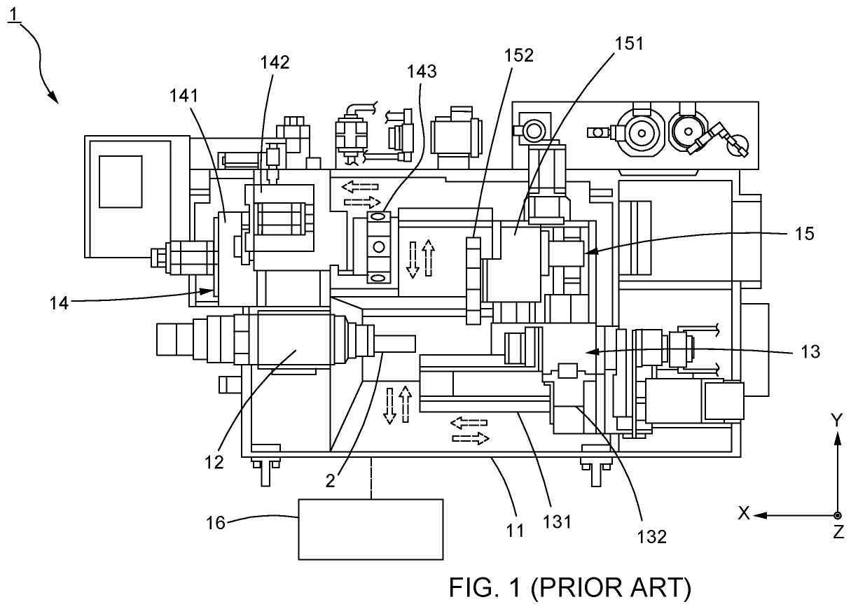

FIGS. 2A and 2B are schematic views showing a rotation of the second carrier to move the flat surface to face the second positioning device;

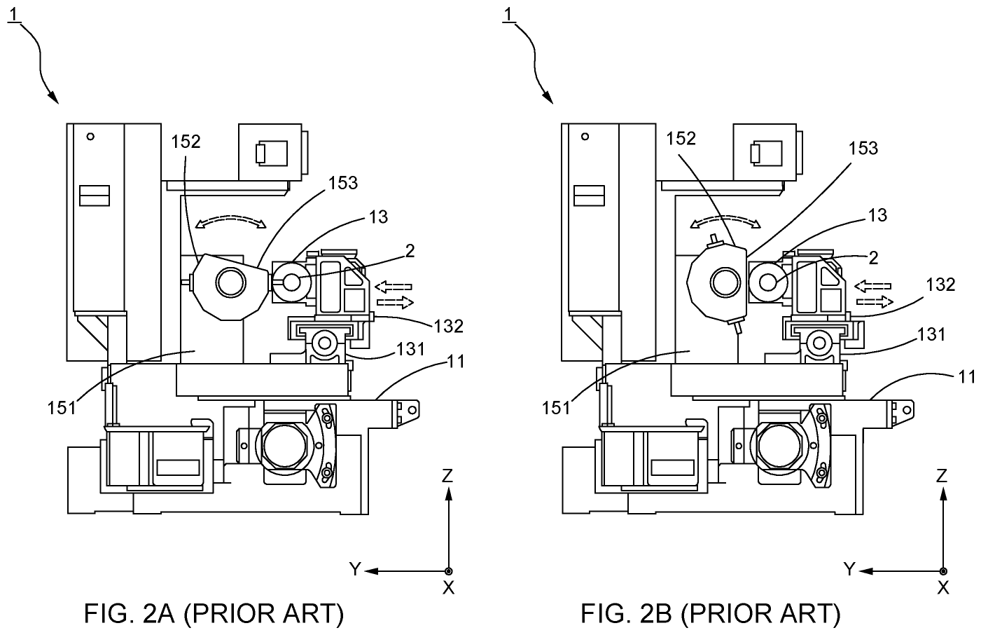

FIG. 3 is a perspective view showing a first preferred embodiment of this invention;

FIGS. 4A and 4B are perspective views showing that the first turning device slides on the second transverse slide rail in the X-axis direction;

FIGS. 5A and 5B are perspective views showing that the first turning device slides on the first longitudinal slide rail in the Y-axis direction;

FIGS. 6A and 6B are perspective views showing that the second turning device slides on the second longitudinal slide rail in the Y-axis direction;

FIG. 7 is a schematic view showing that the first positioning device and the second positioning device clamp the same workpiece;

FIG. 8 is a schematic view showing that the first positioning device and the second positioning device clamp different workpieces;

FIG. 9 is a schematic view showing that the second positioning device and the first turning device slide in the X-axis direction;

FIGS. 10A and 10B are perspective views showing that the first turning device slides on the first elevating unit in the Z-axis direction;

FIGS. 11A and 11B are perspective views showing that the second turning device slides on the second elevating unit in the Z-axis direction;

FIG. 12 is a schematic view showing a second preferred embodiment of this invention;

FIG. 13 is a schematic view showing that the first positioning device and the second positioning device slide on the first transverse slide rail in the X-axis direction; and

FIG. 14 is a schematic view showing that the first positioning device and the second positioning device clamp different workpieces.

### DETAILED DESCRIPTION OF THE PREFERRED EMBODIMENTS

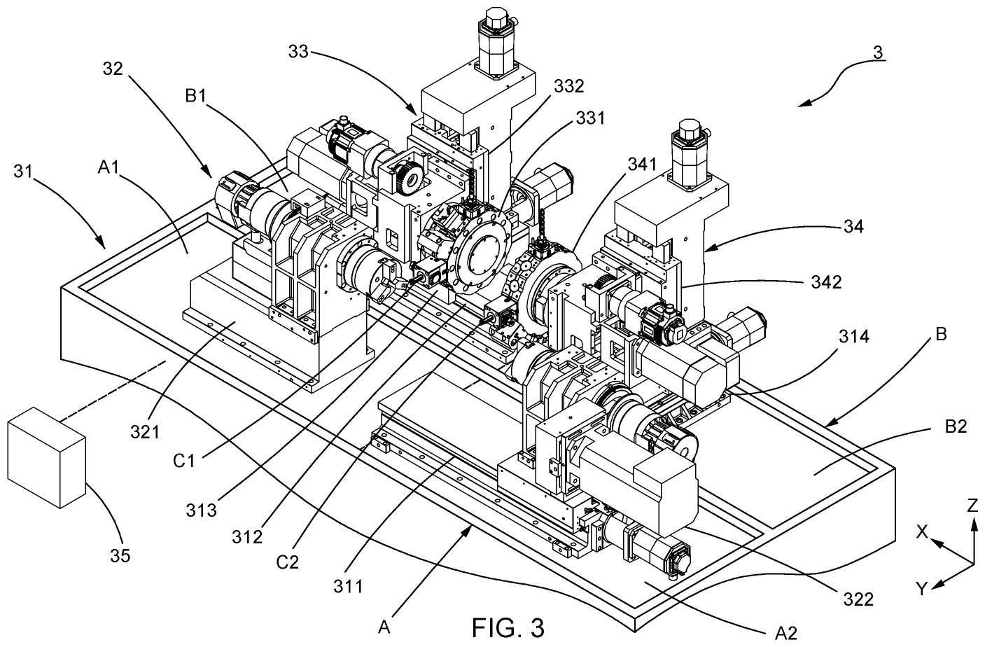

Referring to FIG. 3, a workpiece processing assembly with multiple working operations 3 of a first preferred embodiment of this invention includes a working platform 31, a positioning assembly 32 disposed on the working platform 31 and adapted to clamp at least one workpiece 4 to be processed, a first turning device 33 and a second turning device 34 located beside the positioning assembly 32, and a controlling device 35 electrically connected to the positioning assembly 32, the first turning device 33 and the second turning device 34. The controlling device 35 is adapted to actuate respective operations of the positioning assembly 32, the first turning device 33 and the second turning device 34 based on a control command transmitted to the controlling device 35.

The working platform 31 has a processing portion A and an operating portion B located relative to the processing portion A. The processing portion A defines at least a first processing area A1 and at least a second processing area A2 defined relative to the first processing area A1. The operating portion B defines at least a first operating area B1 defined beside the first processing area A1 and at least a second operating area B2 defined beside the second processing area A2. The working platform 31 has a first transverse slide rail 311 disposed in the second processing area A2, a second transverse slide rail 312 disposed in the first operating area B1, a first longitudinal slide rail 313 slidably disposed on the second transverse slide rail 312, and a second longitudinal slide rail 314 disposed in the second operating area B2. The first longitudinal slide rail 313 and the second longitudinal slide rail 314 are preferably perpendicular to the operating portion B. The working platform 31 defines a three-dimensional baseline including a Y-axis direction, an X-axis direction perpendicular to the Y-axis direction, and a Z-axis direction pointing upward.

The positioning assembly 32 is actuated by the controlling device 35 to clamp or release the workpiece 4. The positioning assembly 32 has a first positioning device 321 disposed in the first processing area A1 and a second positioning device 322 movably disposed on the first transverse slide rail 311 of the second processing area A2 for being adapted to slide in the X-axis direction reciprocatingly. The second positioning device 322 is located relative to the first positioning device 311. In this preferred embodiment, the first positioning device 321 is fixed in the first processing area A1. The first positioning device 321 and the second positioning device 322 can be adapted to clamp two ends of the same workpiece 4 respectively. Alternatively, the first positioning device 321 and the second positioning device 322 can be adapted to clamp different workpieces 4. Meanwhile, the controlling device 35 can drive the second positioning device 322 to slide on the first transverse slide rail 311 to further adjust the distance between the first positioning device 321 and the second positioning device 322.

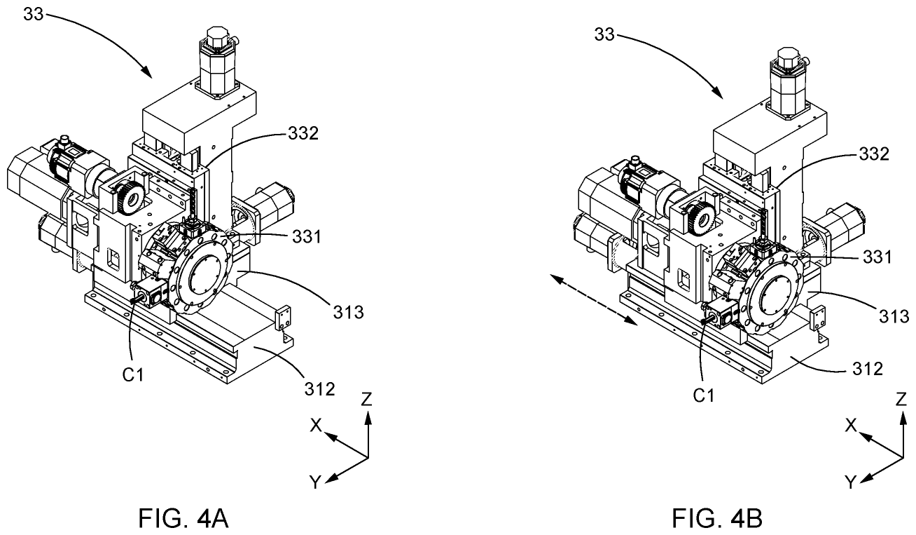

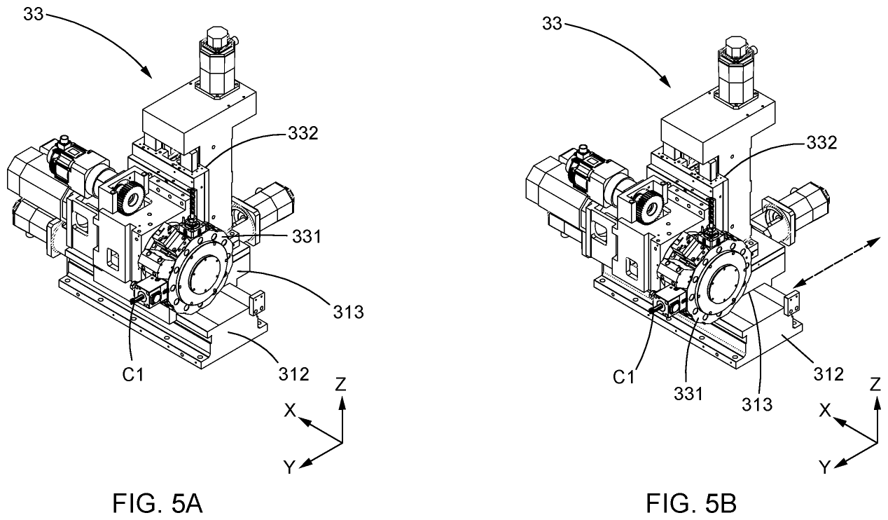

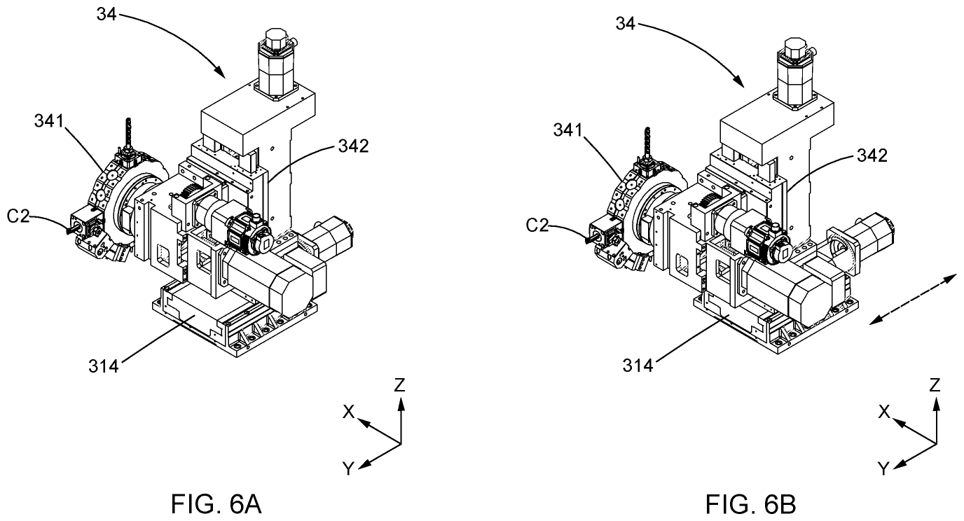

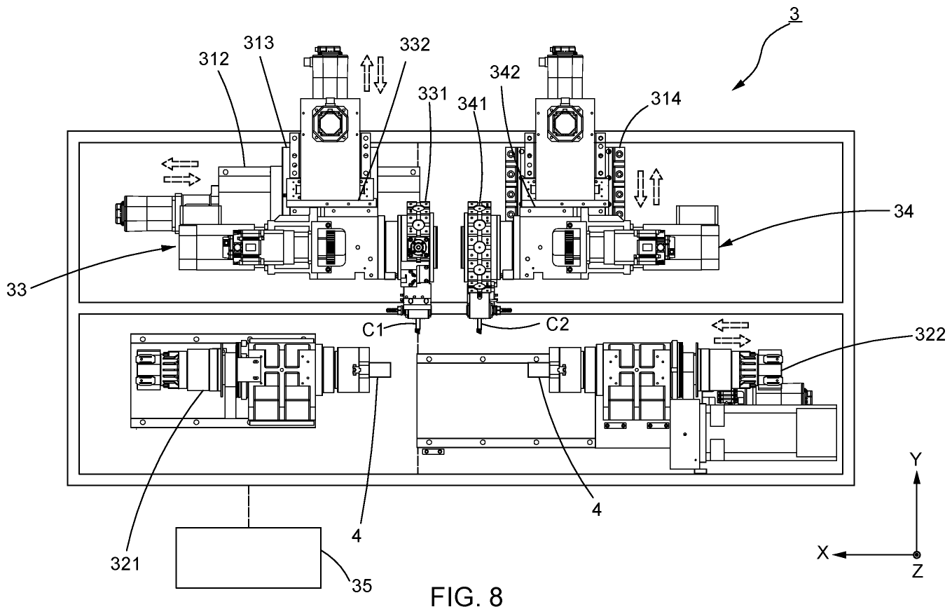

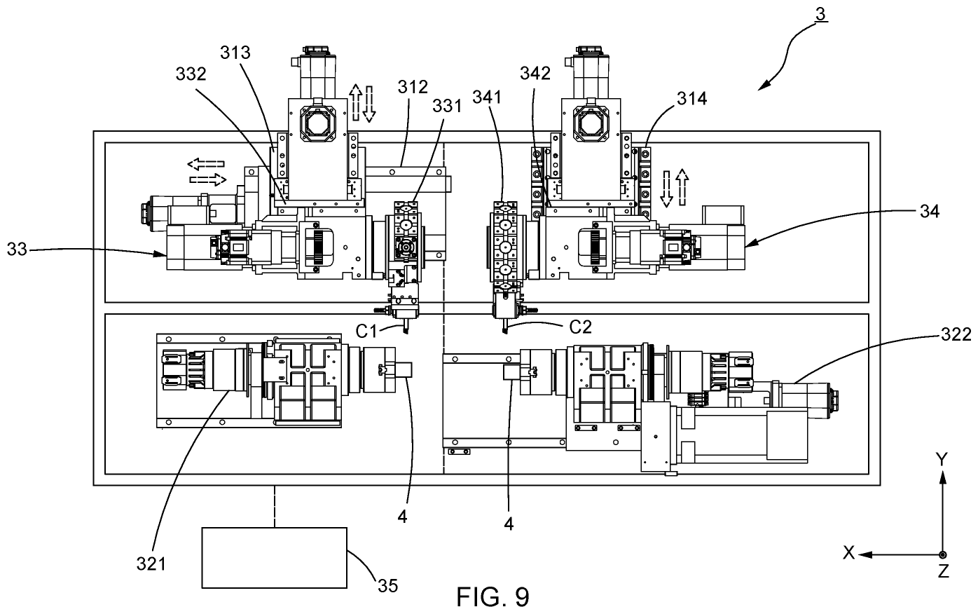

The first turning device 33 is situated beside the first positioning device 321 and is movably disposed on the first longitudinal slide rail 313 of the first operating area B1 for being adapted to slide in the Y-axis direction reciprocatingly as shown in FIG. 4A and FIG. 4B. Referring to FIG. 5A and FIG. 5B, the first turning device 33 is capable of sliding in the X-axis direction reciprocatingly by sliding the first longitudinal slide rail 313 along the second transverse slid rail 312. The first turning device 33 has a first carrier 331 adapted to accommodate at least two first processing tools C1 serving to turn the workpiece 4. Further, the second turning device 34 is situated beside the second positioning device 322 and is movably disposed on the second longitudinal slide rail 314 of the second operating area B2 for being adapted to slide in the Y-axis direction reciprocatingly as shown in FIG. 6A and FIG. 6B. The second turning device 34 has a second carrier 341 adapted to accommodate at least two second processing tools C2. The controlling device 35 can carry out a rotation of the first carrier 331 and the second carrier 341 respectively so that the needed first processing tool C1 and needed second processing tool C2 are rotated to face the workpiece 4 automatically. Meanwhile, each first processing tool C1 and each second processing tool C2 is capable of rotating on its own axis to achieve different working operations. Moreover, the controlling device 35 can also drive the first turning device 33 to slide on the second transverse slide rail 312 and the first longitudinal slide rail 313 to adjust the distance between the first turning device 33 and the first positioning device 321 and drive the second turning device 34 to slide on the second longitudinal slide rail 314 to adjust the distance between the second turning device 34 and the second positioning device 322 to thereby move the first processing tool C1 and the second processing tool C2 to a proper processing position. Referring to FIG. 8A and FIG. 8B, in this preferred embodiment, the first turning device 33 is movably disposed on a first elevating unit 332 for being adapted to slide in the Z-axis direction reciprocatingly. Referring to FIG. 9A and FIG. 9B, the second turning device 34 is movably disposed on a second elevating unit 342 for being adapted to slide in the Z-axis direction reciprocatingly. Thus, the first turning device 33 and the second turning device 34 are capable of processing each side and each surface of the workpiece 4 based on different working operations.

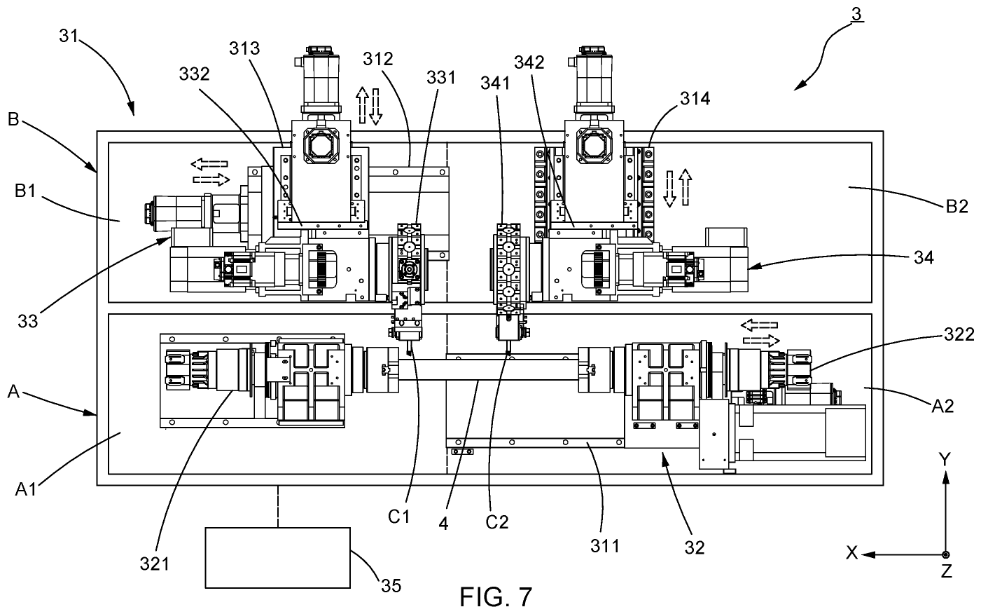

Referring to FIG. 7, here takes an example that the turning process is aimed at processing the same workpiece 4. During the turning process of the workpiece 4, the first positioning device 321 is adapted to clamp one end of the workpiece 4. The second positioning device 322 then actuated by the controlling device 35 to slide on the first transverse slide rail 311 in the X-axis direction toward the first positioning device 321 to thereby clamp another end of the workpiece 4. Hence, the workpiece 4 is fixed stably between the first positioning device 321 and the second positioning device 322. After that, the controlling device 35 actuates the first turning device 33 and the second turning device 34 to carry out a rotation of the first carrier 331 and the second carrier 341 respectively to further situate the needed first processing tool C1 and the needed second processing tool C2 to face the workpiece 4. Next, the controlling device 35 actuates the first turning device 33 to slide on the second transverse slide rail 312 in the X-axis direction to further aim the first processing tool C1 at the workpiece 4. The first turning device 33 then slides on the first longitudinal slide rail 313 in the Y-axis direction to adjust the distance between the workpiece 4 and the first processing tool C1. Thus, the first processing tool C1 of the first turning device 33 is moved to a proper processing position for processing the workpiece 4. During the adjustment of the first turning device 33, the controlling device 35 simultaneously actuates the second turning device 34 to slide on the second longitudinal slide rail 314 in the Y-axis direction to further adjust the distance between the workpiece 4 and the second processing tool C2, and the second processing tool C2 is then moved to a proper processing position for processing the workpiece 4. Thus, the workpiece 4 can be processed simultaneously by the first turning device 33 and the second turning device 34.

Referring to FIG. 8 and FIG. 9, here takes an example that the turning process is aimed at processing different workpieces 4. During the turning process of two workpieces 4, the first positioning device 321 and the second positioning device 322 are adapted to clamp different workpieces 4 respectively. Next, the controlling device 35 actuates the first turning device 33 and the second turning device 34 to carry out a rotation of the first carrier 331 and the second carrier 341 respectively to further move the needed first processing tools C1 to face the corresponding workpiece 4 and move the needed second processing tool C2 to face the corresponding workpiece 4. After that, the controlling device 35 actuates the second positioning device 322 to slide on the first transverse slide rail 311 in the X-axis direction to situate the workpiece 4 relative to the second processing tool C2 of the second turning device 34. The controlling device 35 then actuates the second turning device 34 to slide on the second longitudinal slide rail 314 in the Y-axis direction to situate the second processing tool C2 in a proper processing position for processing the corresponding workpiece 4 clamped by the second positioning device 322. Simultaneously, the controlling device 35 actuates the first turning device 33 to slide on the second transverse slide rail 312 in the X-axis direction to further position the first processing tool C1 relative to the corresponding workpiece 4. The first turning device 33 then slides on the first longitudinal slide rail 313 in the Y-axis direction to move the first processing tool C1 to a proper processing position for processing the corresponding workpiece 4 clamped by the first positioning device 321. Hence, the first turning device 33 and the second turning device 34 can process different workpieces 4 respectively.

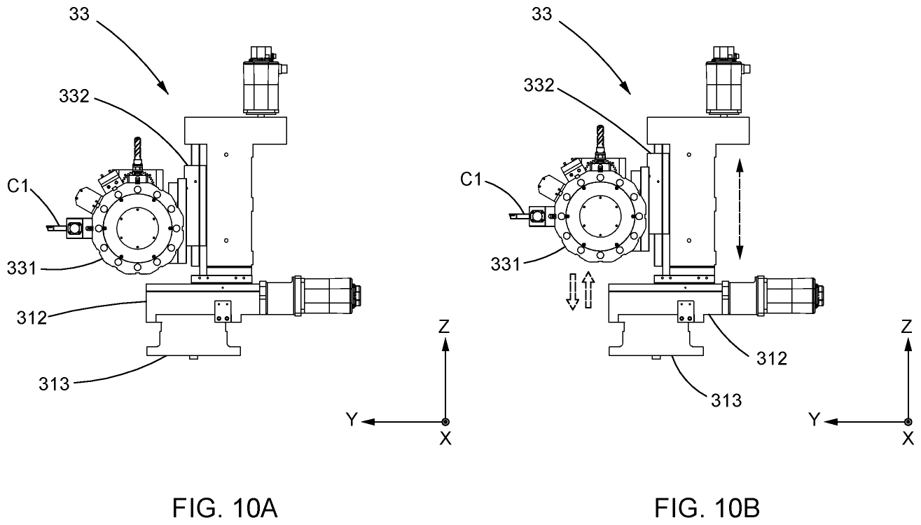

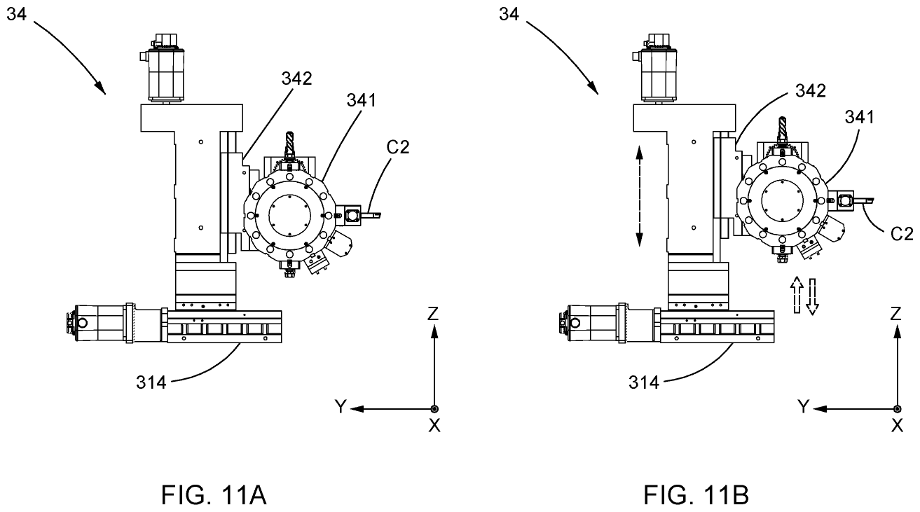

Referring to FIG. 3, FIGS. 10A-10B and FIGS. 11A-11B, the controlling device 35 can actuate the first turning device 33 to slide on the first elevating unit 332 in the Z-axis direction to adjust the height of the first processing tool C1 of the first turning device 33. Meanwhile, the second turning device 34 can slide on the second elevating unit 342 in the Z-axis direction to adjust the height of the second processing tool C2 of the second turning device 34. Therefore, the first processing tool C1 and the second processing tools C2 are precisely moved to aim at the workpiece 4 effectively. Thus, the workpiece processing assembly with multiple working operations 3, unlike the conventional machine tool 1, does not require the flat surface 153 (not shown) to prevent the second positioning device 322 from colliding with the second turning device 34. Hence, the second carrier 341 can be equipped with more second processing tools C2. Moreover, the workpiece processing assembly 3 can simultaneously process the same workpiece 4 or different workpieces 4 according to needs and execute the multiple working operations smoothly and speedily. Meanwhile, a rotation of the first carrier 331 and the second carrier 341 actuated by the controlling device 35 allows the first processing tools C1 and the second processing tools C2 to be changed automatically to thereby avoid the inconvenience caused by replacing the first processing tools C1 and the second processing tools C2 manually. Thus, the processing efficiency is increased and the processing quality is improved.

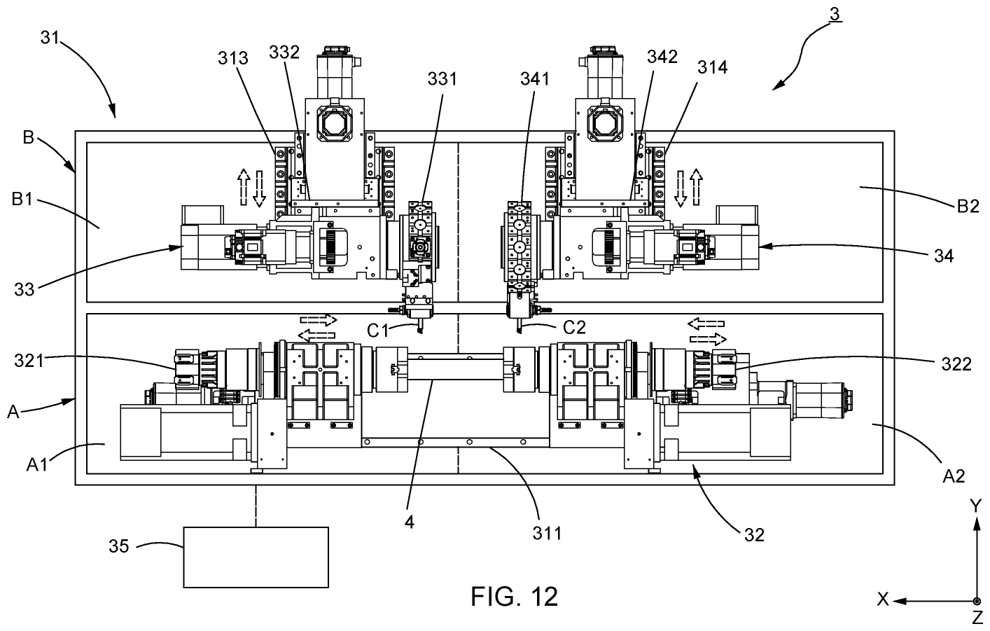

Referring to FIG. 12 shows a second preferred embodiment of the workpiece processing assembly with multiple working operations 3 of this invention. The correlated elements and the concatenation of elements, the operation and objectives of the second preferred embodiment are the same as those of the first preferred embodiment. This embodiment is characterized in that the first transverse slide rail 311 extends from the second processing area A2 to the first processing area A1. Both of the first positioning device 321 and the second positioning device 322 of the positioning assembly 32 are movably disposed on the first transverse slide rail 311 for being adapted to slide in the X-axis direction reciprocatingly. The first turning device 33 is movably disposed on the first longitudinal slide rail 313 of the first operating area B1 to slide in the Y-axis direction reciprocatingly. The second turning device 34 is movably disposed on the second longitudinal slide rail 314 of the second operating area B2 for being adapted to slide in the Y-axis direction reciprocatingly.

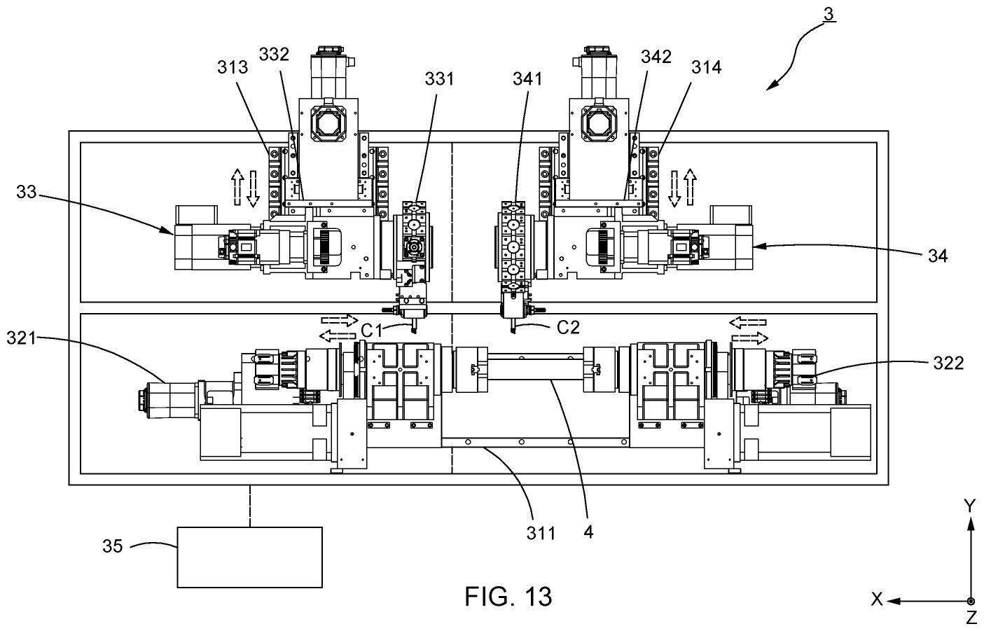

Referring to FIG. 12 and FIG. 13, here takes an example that the turning process is aimed at processing the same workpiece 4. During the turning process of the workpiece 4, the first positioning device 321 and the second positioning device 322 slide on the first transverse slide rail 311 in the X-axis direction to clamp two ends of the same workpiece 4 respectively and move the workpiece 4 relative to the first turning device 33 and the second turning device 34. Meanwhile, the first turning device 33 slides on the first longitudinal slide rail 313 in the Y-axis direction to move the first processing tool C1 to a proper position for processing the workpiece 4. The second turning device 34 slides on the second longitudinal slide rail 314 in the Y-axis direction to move the second processing tool C2 to a proper processing position for processing the workpiece 4. Therefore, multiple working operations of the turning process can be executed smoothly. The processing efficiency is increased and the processing quality is improved effectively.

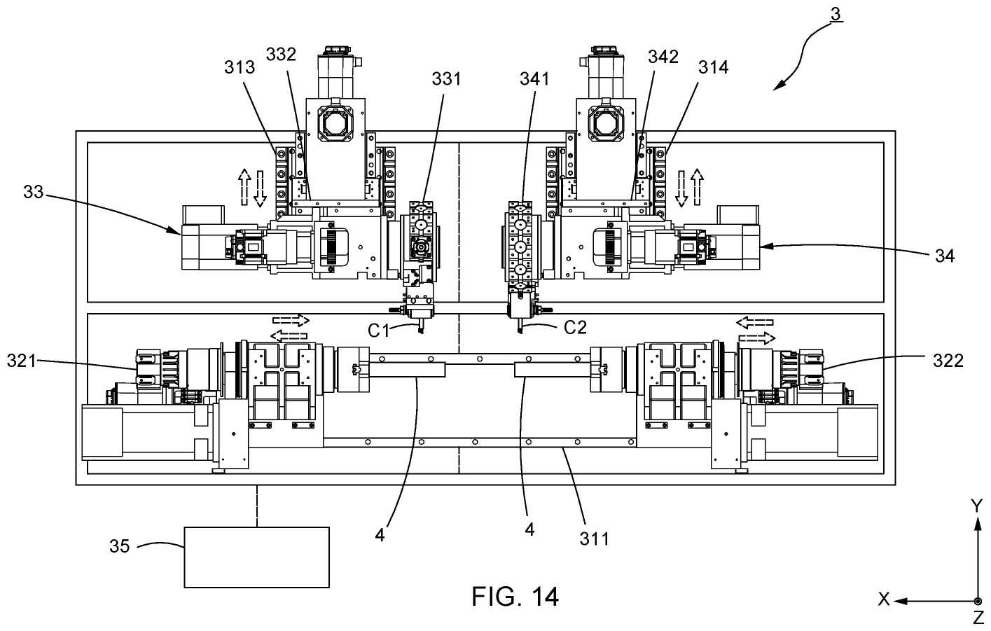

Referring to FIG. 14, here takes an example that the turning process is aimed at processing different workpieces 4. During the turning process of different workpieces 4, the first positioning device 321 and the second positioning device 322 clamp different workpieces 4 respectively. The first positioning device 321 then slides on the first transverse slide rail 311 in the X-axis direction to situate the workpiece 4 relative to the first turning device 33. After that, the first turning device 33 slides on the first longitudinal slide rail 313 in the Y-axis direction to move the first processing tool C1 to a proper position for processing the workpiece 4 clamped by the first positioning device 321. Simultaneously, the second positioning device 322 also slides on the first transverse slide rail 311 in the X-axis direction to situate the workpiece 4 relative to the second turning device 34. The second turning device 34 then slides on the second longitudinal slide rail 314 in the Y-axis direction to move the second processing tool C2 to a proper position for processing the workpiece 4 clamped by the second positioning device 322. The first processing tool C1 of the first turning device 33 and the second processing tool C2 of the second turning device 34 can be changed automatically by the rotation of the first carrier 331 and the second carrier 341 actuated by the controlling device 35 to thereby complete the multiple working operations of the turning process.

To sum up, the workpiece processing assembly with multiple working operations of this invention takes advantages of the first transverse slide rail to adjust the distance between the first positioning device and the second positioning device to thereby clamp at least one workpiece stably, the second transverse slide rail and the first longitudinal slide rail to adjust the distance between the first positioning device and the first turning device to thereby move the first processing tool to a proper processing position, and the second longitudinal slide rail to adjust the distance between the second positioning device and the second turning device to thereby move the second processing tool to a proper processing position. Thus, multiple working operations can be executed smoothly and speedily. The inconvenience caused by replacing processing tools during the turning process is prevented, the processing efficiency is increased effectively, and the processing quality is improved.

While the embodiments of this invention are shown and described, it is understood that further variations and modifications may be made without departing from the scope of this invention.

What is claimed is:

1. A workpiece processing assembly with multiple working operations comprising:
a working platform including a processing portion and an operating portion located relative to said processing portion, said processing portion defining at least a first processing area and at least a second processing area defined relative to said first processing area, said operating portion defining at least a first operating area defined beside said first processing area and at least a second operating area defined beside said second processing area, said working platform including a first transverse slide rail disposed in said second processing area, a second transverse slide rail disposed in said first operating area, a first longitudinal slide rail slidably disposed on said second transverse slide rail, and a second longitudinal slide rail disposed in said second operating area, said working platform defining a three-dimensional baseline including a Y-axis direction, an X-axis direction perpendicular to said Y-axis direction, and a Z-axis direction pointing upward;
a positioning assembly disposed on said working platform and adapted to clamp at least one workpiece to be processed, said positioning assembly including a first positioning device disposed in said first processing area and a second positioning device movably disposed on said first transverse slide rail of said second processing area for being adapted to slide in said X-axis direction reciprocatingly, said second positioning device being situated relative to said first positioning device;
a first turning device movably disposed on said first longitudinal slide rail of said first operating area for being adapted to slide in said Y-axis direction reciprocatingly, said first turning device being adapted to move in said X-axis direction reciprocatingly by sliding said first longitudinal slide rail along said second transverse slid rail, said first turning device being situated beside said first positioning device, said first turning device including a first carrier adapted to accommodate at least two first processing tools serving to turn said at least one workpiece to be processed;
a second turning device movably disposed on said second longitudinal slide rail of said second operating area for being adapted to slide in said Y-axis direction reciprocatingly, said second turning device being situated beside said second positioning device, said second turning device including a second carrier adapted to accommodate at least two second processing tools serving to turn said at least one workpiece to be processed; and
a controlling device electrically connected to said first positioning device, said second positioning device, said first turning device and said second turning device for actuating respective operations of said first positioning device, said second positioning device, said first turning device and said second turning device according to a control command transmitted to said controlling device.

2. The workpiece processing assembly with multiple working operations according to claim 1, wherein said first positioning device disposed in said first processing area is adapted to clamp one end of said at least one workpiece to be processed, and said second positioning device disposed in said second processing area is adapted to clamp another end of said at least one workpiece to be processed.

3. The workpiece processing assembly with multiple working operations according to claim 1, wherein said first positioning device disposed in said first processing area and said second positioning device disposed in said second processing area are adapted to clamp different workpieces to be processed.

4. The workpiece processing assembly with multiple working operations according to claim 1, further comprising a first elevating unit on which said first turning device is disposed, said first turning device being movably disposed on said first elevating unit for being adapted to slide in said Z-axis direction reciprocatingly.

5. The workpiece processing assembly with multiple working operations according to claim 1, further comprising a second elevating unit on which said second turning device is disposed, said second turning device being movably disposed on said second elevating unit for being adapted to slide in said Z-axis direction reciprocatingly.

6. A workpiece processing assembly with multiple working operations comprising:
a working platform including a processing portion and an operating portion located relative to said processing portion, said processing portion defining at least a first processing area and at least a second processing area defined relative to said first processing area, said operating portion defining at least a first operating area defined beside said first processing area and at least a second operating area defined beside said second processing area, said working platform including a first transverse slide rail extending from said first processing area to said second processing area, a first longitudinal slide rail disposed in said first operating area, and a second longitudinal slide rail disposed in said second operating area, said working platform defining a three-dimensional baseline including a Y-axis direction, an X-axis direction perpendicular to said Y-axis direction, and a Z-axis direction pointing upward;
a positioning assembly disposed on said working platform and adapted to clamp at least one workpiece to be processed, said positioning assembly including a first positioning device movably disposed on said first transverse slide rail for being adapted to slide in said X-axis direction reciprocatingly and a second positioning device movably disposed on said first transverse slide rail for being adapted to slide in said X-axis direction reciprocatingly, said second positioning device being situated relative to said first positioning device;
a first turning device movably disposed on said first longitudinal slide rail of said first operating area for being adapted to slide in said Y-axis direction reciprocatingly, said first turning device being situated beside said first positioning device, said first turning device including a first carrier adapted to accommodate at least two first processing tools serving to turn said at least one workpiece to be processed;
a second turning device movably disposed on said second longitudinal slide rail of said second operating area for being adapted to slide in said Y-axis direction reciprocatingly, said second turning device being situated beside said second positioning device, said second turning device including a second carrier adapted to accommodate at least two second processing tools serving to turn said at least one workpiece to be processed; and
a controlling device electrically connected to said first positioning device, said second positioning device, said first turning device and said second turning device for actuating respective operations of said first positioning device, said second positioning device, said first turning device and said second turning device according to a control command transmitted to said controlling device.

7. The workpiece processing assembly with multiple working operations according to claim 6, wherein said first positioning device is adapted to clamp one end of said at least one workpiece to be processed, and said second positioning device is adapted to clamp another end of said at least one workpiece to be processed.

8. The workpiece processing assembly with multiple working operations according to claim 6, wherein said first positioning device disposed in said first processing area and said second positioning device disposed in said second processing area are adapted to clamp different workpieces to be processed.

9. The workpiece processing assembly with multiple working operations according to claim 6, further comprising a first elevating unit on which said first turning device is disposed, said first turning device being movably disposed on said first elevating unit for being adapted to slide in said Z-axis direction reciprocatingly.

10. The workpiece processing assembly with multiple working operations according to claim 6, further comprising a second elevating unit on which said second turning device is disposed, said second turning device being movably disposed on said second elevating unit for being adapted to slide in said Z-axis direction reciprocatingly.
